(19) United States
(12) Patent Application Publication
(10) Pub. No.: US 2008/0196623 A1
(43) Pub. Date: Aug. 21, 2008

(54) Multiple Component Multiple Layer Coating Composition and Method of Application

(76) Inventor: Mark Berens, Westerville, OH (US)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 11/676,435

(22) Filed: Feb. 19, 2007

(51) Int. Cl. C09K 3/14

(52) U.S. Cl. 106/36; 106/287.34; 427/133

(57) ABSTRACT

A multiple layer coating composition comprising at least one first layer comprising a first layer resin and an aggregate and at least one color layer comprising a color layer resin and a color layer pigment. Additional color layers and or a top layer comprising a top layer resin may be added. The components of each layer are blended together with a polymerization initiator prior to application to a base and each cured to form a coating. The present invention is also directed to a method of producing a coating on a base and to the resulting coated base.

### FIELD OF THE INVENTION

The present invention relates to a multi-layered coating composition and more specifically to a layered coating composition formed by applying one or more fluent materials, each of which solidify prior to the application of the next layer.

### BACKGROUND OF THE INVENTION

Coatings are employed for a multitude of reasons, such as for waterproofing, increased wear resistance, ease of cleaning, aesthetics, and the like. The ability of a coating to provide such properties improves with the addition of certain materials.

Known coverings, such as those used for floors, walls, ceilings, patios, and the like, generally include combining an aggregate, a binder, a filler, and possibly a pigment. Known coverings are spread over a base, such as wood, metal, concrete or plastic, to create a protective and durable coating.

The application of a coating to a base such as a floor, driveway, or patio presents certain challenges. In retail establishments, such as restaurants, grocery stores, malls, retail stores, manufacturing facilities, showrooms, stadiums, and the like, very large areas must be covered. Existing flooring systems typically require 8-48 hours at a temperature of 15-20° C. to dry or cure. These establishments typically must shut down during the installation creating delays, inconvenience, and lost revenues.

The application of a coating, particularly to a floor, patio, driveway, and the like, sometimes includes adding a stain to concrete. Concrete is porous and absorbs stain; however, the porosity also allows the concrete to harbor bacteria and mold. Stains added to concrete are typically acid, water, solvent, or oil based—all of which dry by evaporation. The “wet” product is not the same dimension as the finished product due to evaporation, so an installer must correctly calculate the amount of additional thickness in order to maintain an even surface with existing surfaces. Existing coatings cannot be applied too thickly because the final shape will warp due to uneven evaporation. Due to evaporation, existing coatings must be applied at a minimum temperature, typically above freezing.

Colors available for stained concrete are limited and not very colorful. The condition of the concrete typically dictates how well it stains. Once installed, the color of an existing stained concrete is expensive and time consuming to change. Extensive work must be done to mechanically remove the concrete and replace with the desired color.

Other materials exist that provide coatings for concrete and other materials. Pigmented acrylic coatings provide a surface that is smoother, less porous, and easier to keep clean. However, pigmented acrylic coatings are not capable of withstanding the high temperatures that stained concrete and ceramics are capable of withstanding. In addition, pigmented acrylic coatings typically create a single, solid color.

A need exists for a material that combines the toughness of concrete with the advantages of an acrylic coating. A need exists for a material that can be used as a coating for a high use area, such as a floor, driveway, patio, and the like, that allows use of the area in a short period of time after installation at a variety of temperatures. A need exists for a material that can cover imperfections, such as cracks, holes, joints, voids, and the like, in concrete, tile, asphalt and other surfaces. A need exists for an easy to maintain, protective, durable, waterproof and aesthetic material that coats ceramics, wood, metal, concrete, plastic, and the like, that does not absorb bacteria, molds, unwanted coloring, and chemicals.

### SUMMARY OF THE INVENTION

The present invention provides a coating that is fast drying and 100% non-porous. The present invention is more versatile than existing coatings, providing a colorful surface or a refinished surface for both interior and exterior applications, such as floors, walls, ceilings, countertops, sinks, tubs, shower stalls, patios, walks, solid driveways, sidewalks, and the like, as well as formed materials, tiles, casting items, and the like.

The present invention fills voids, cracks, and joints in a base surface and can be installed at any desired thickness. The present invention restructures and adheres to concrete, plaster, stucco, ceramic, quarry tile, wood, metal, plastic, asphalt, and the like.

The coating of the present invention is 100% non-porous, does not absorb liquids, is chemical resistant, anti-microbial, and slip resistant. It is UV-stable, provides industry rated compressive, tensile and flexural strength, and allows for expansion. The present invention provides resistance to deicing salts, muraitic acid, food acids, sugar solutions, gasoline, oil, water, and the like. The present invention meets FDA and health department standards as a coating solution useful for surfaces in regulated industries, such as but not limited to floors in food processing, food retailing, pharmaceutical manufacturing, daycare facilities, and the like, as well as regular retail and industrial plant facilities. The present invention is also useful for residential applications.

The coating of the present invention provides a multitude of colors, patterns, and designs. In an embodiment, the system uses a very small amount of pigment to create a shading and provide a translucent effect. The present invention provides for custom coloring. In an embodiment, additional layers and colors are added to give different tints and shading to produce a desired look, including that of stained concrete. In addition, the present invention provides a coating where the color is easy to change as many times as desired, while requiring no periodic resealing or recurring.

The present invention does not cure by evaporation; therefore the coating can be installed at any thickness and with minimal warping or shrinking. The present invention is applicable to interior or exterior bases. It can be installed at temperatures as low as −30° F. The present invention allows for restructuring of a base, use on sloped bases, and covering blemishes in an existing base. In an embodiment, the present invention is applied to an existing concrete floor to provide the look of stained concrete while providing a durable surface that does not show wear patterns.

The present invention requires only a few hours of down time of a business to install as a coating on an area such as a floor, patio, driveway, and the like. It can be further finished to include a pattern, such as a broom finish, swirl patterns, smooth finish, and the like. In an embodiment, different colors are applied to parts of a base to create a logo, design, pattern, defined area such as a walkway or aisle, and the like.

In an embodiment, the present invention comprises at least one first layer comprising a first layer resin and an aggregate and at least one color layer comprising a color layer resin and at least one color layer pigment. The first layer is blended with a polymerization initiator, applied, and allowed to cure and the color layer is blended with a polymerization initiator and applied over the first layer. In an embodiment, the first layer further comprises at least one of a substrate and a first layer pigment. In an embodiment, the color layer further comprises a filler. In an embodiment, the present invention comprises at least one top layer comprising a top layer resin. The top layer is blended with a polymerization initiator prior to application and applied over the color layer.

In an embodiment, the first layer resin comprises from about 40% to about 70% by weight relative to the total weight of the first layer resin and the aggregate comprises from about 30% to about 60% by weight relative to the total weight of the first layer. In an embodiment, the color layer resin comprises about 99% by weight relative to the total weight of the color layer and the color layer pigment comprises about 1% by weight relative to the total weight of the color layer. In an embodiment, the first layer resin comprises from about 30% to about 60% by weight relative to the total weight of the first layer resin, and the substrate comprises from about 10% to about 30% by weight relative to the total weight of the first layer, the aggregate comprises from about 10% to about 40% by weight relative to the total weight of the first layer, and the first layer pigment comprises from about 0.01% to about 1.5% by weight relative to the total weight of the first layer. In an embodiment, the color layer resin comprises from about 30% to about 60% by weight relative to the total weight of the color layer, the filler comprises from about 20% to about 70% by weight relative to the total weight of the color layer, and the color layer pigment comprises from about 0.005% to about 1% by weight relative to the total weight of the color layer.

In an embodiment, the resin is selected from the group consisting of an epoxy, a polyurethane and an acrylic resin. In an embodiment, the aggregate is selected from the group consisting of a cement, a sand, a gravel, a crushed stone, and a recycled concrete, a silica sand, a fumed silica, and a silica flour. In an embodiment, the substrate is selected from the group consisting of a cement, a sand, a gravel, a crushed stone, and a recycled concrete, a silica sand, a fumed silica, and a silica flour. In an embodiment, the filler is selected from the group consisting of a silica filler, a fumed silica and precipitated silica.

In an embodiment, the top layer further comprises a pigment. In an embodiment, the top layer further comprises at least one of a compound to provide slip resistance and a modifier. In an embodiment, the layers are applied by at least one of spraying, troweling, squeegeeing, scraping, brushing, rolling and power troweling.

In an embodiment, the coating of the present invention is provided in a kit comprising at least one resin, at least one of a hydraulic cement, a fumed silica, a silica sand, and a silica flour, and a polymerization activator. In an alternate embodiment, the kit comprises a pre-mix comprising a first layer comprising a first layer resin, a substrate, and an aggregate; a pre-mix comprising a color layer comprising a color layer resin and a filler; a top layer comprising a top layer resin; and a polymerization initiator. In an embodiment, a companion kit of an array of pigments is provided.

The present invention comprises a method of applying the coating composition comprising applying the first layer to a base; providing a sufficient amount of time for the first layer to cure; applying at least one color layer over the first layer; and providing a sufficient amount of time for the color layer to cure. Optionally, a primer is applied to a base prior to the application of the first layer. Alternately, a top layer is applied over the color layer.

The coating of the present invention is also formed by sequentially injecting the layers into a mold.

The term “cured” as uses herein means a curable material that has been sufficiently solidified.

The term “silica flour” as used herein is intended to mean a fine quartz and or sand (at least about 200 mesh).

As used herein, “silica sand” means a medium to fine silica sand (from about 30 to about 140 mesh).

The term “hydraulic cement” as used herein is intended to mean polymer cements, Portland cements, expansive cements, air entraining Portland cements, pozzolanic cements, slag cement, masonry cement, white Portland cement, colored cement, antibacterial cement, waterproof cement, a mixture of Portland cement and blast furnace cement, refractory cement, self-stressing cement, aluminous cement, and similar materials.

As used herein, “approximately” means within plus or minus 25% of the term it qualifies. The term “about” means between ½ and 2 times the term it qualifies.

All percentages, parts and ratios as used herein are by weight of the total composition, unless otherwise specified. All such weights as they pertain to listed ingredients are based on the active level and, therefore, do not include other products that may be included in commercially available materials, unless otherwise specified.

The compositions and methods of the present invention can comprise, consist of, or consist essentially of the essential elements and limitations of the invention described herein, as well as any additional or optional ingredients, components, or limitations described herein or otherwise useful in compositions and methods of the general type as described herein.

Numerical ranges as used herein are intended to include every number and subset of numbers contained within that range, whether specifically disclosed or not. Further, these numerical ranges should be construed as providing support for a claim directed to any number or subset of numbers in that range.

All references to singular characteristics or limitations of the present invention shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

### BRIEF DESCRIPTION OF THE DRAWINGS

FIG. 1 is a cross-sectional view of an embodiment of the present invention.

FIG. 2 is an alternate cross-sectional view of an embodiment of the present invention.

FIG. 3 is a flow diagram illustrating a method of applying an embodiment of the present invention.

FIG. 4 is an embodiment of the coating composition prepared using components of the examples.

FIG. 5 is an alternate embodiment of the coating composition prepared using components of the examples.

### DETAILED DESCRIPTION OF THE INVENTION

The present invention comprises a multi-layer coating composition applicable to a variety of interior and exterior surfaces. In an embodiment, the coating is applied to a preformed base, such as floors, ceilings, walls, countertop, sinks, tubs, shower stalls, tables, patios, walks, solid driveways, sidewalks, and the like. Suitable base surfaces are those sufficiently rigid and strong to resist significant flexing. In an embodiment, a suitable base is flexible up to about 150%. Suitable bases include but are not limited to concrete, plaster, stucco, ceramic, quarry tile, wood, metal, plastic, and asphalt. In an embodiment, the coating may be injected into a mold.

In an embodiment, the base is prepared prior to application of the coating. Preparation includes but is not limited to sandblasting, shot blasting, diamond grinding, treating with a solvent, high pressure washing, and the like. In an embodiment, at least one primer 100 is applied to the base prior to the coating. Suitable methods of applying the primer 100 include those that thoroughly wet the base, such as but are not limited to brushing, rolling, squeegeeing, spraying, troweling, and the like. The primer layer 100 is allowed to cure prior to applying the coating of the present invention. Suitable primers are determined according to the material of the base. One skilled in the art would understand that any suitable primer includes those that promote adhesion between layers of materials and or saturate porous bases. In an embodiment, the primer layer 100 is a solution of acrylic polymer in methyl acrylic acid esters to which an activator is added prior to application.

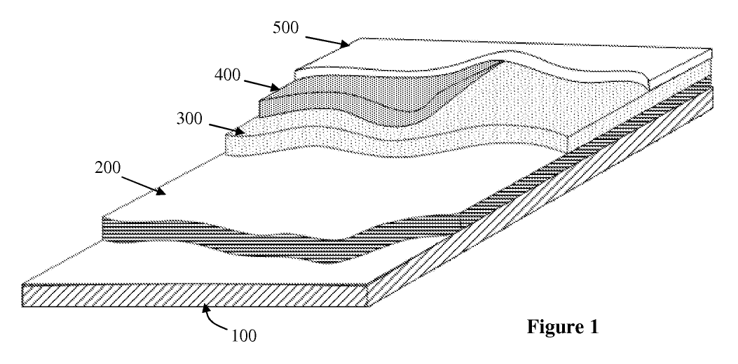

As shown in FIG. 1, the present invention comprises at least one first layer 200 comprising a resin and an aggregate, and at least one color layer 300 comprising a resin and a pigment. In an embodiment, the present invention comprises at least one top layer 500 comprising a resin. In an embodiment, the first layer 200 comprising a resin, an aggregate and a pigment. In an embodiment, the first layer 200 comprising a resin, an aggregate, a substrate, and a pigment. In an embodiment, the coating of the present invention comprises at least one additional color layer 400. In an embodiment, the color layer 300 and or the additional color layer 400 further comprise a filler. In an embodiment, the top layer 500 comprises a pigment.

A polymerization activator is added to each of the layers prior to application. In an embodiment, the first layer 200 is applied to the base and or the primer 100. After the first layer 200 is cured, the activated color layer 300 is applied over the first layer 200 and allowed to cure. In an embodiment, after the color layer 300 is cured, the second color layer 400 and or the activated top layer 500 is applied over the color layer 300 and allowed to cure.

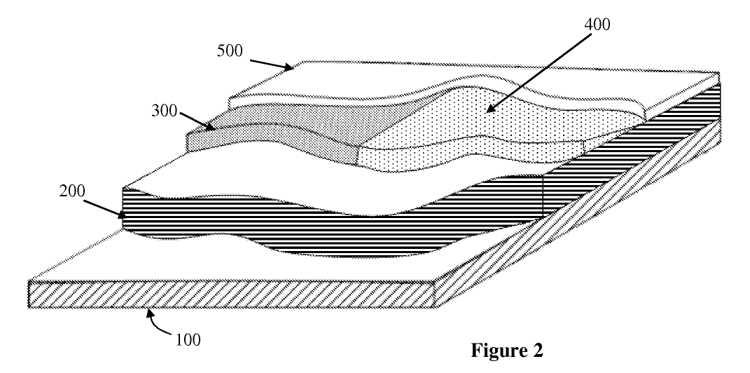

In an embodiment, a second color layer 400 is applied. In an embodiment, the color layer 300 is applied to all of the first layer 200 and the second color layer 400 is applied to all or portions of the color layer 300. In an embodiment depicted in FIG. 2, the color layer 300 is applied to portions of the first layer 200 and the second color layer 400 is applied to alternate portions of the first layer 200. In an embodiment, least one pigment of the color layer 300 is different from a pigment in the second color layer 400. In an embodiment, additional layers are applied to create different hues and or a variation in color, shading, and the like. In an embodiment at least one of the color layer 300 and the second color layer are applied to create a graphic, such as but not limited to a logo.

In an embodiment, the resin is used in each of the layers as a binder. Suitable resins include but are not limited to epoxies, polyurethanes, and acrylics. In an embodiment, the resin is an acrylic resin used for both casting and coating. In an embodiment, the resin improves toughness, flexibility, adhesion, and chemical resistance. One skilled in the art would understand that other binders may be used in place of or in addition to the resin, such as but not limited to an acrylic, an acrylic polymer, a rubber, an epoxy, a vinyl, a styrene, urethane, a polymer and mixtures thereof. In an embodiment, an additive and or a modifier is added to the resin, such as but not limited to a plasticizer, a cross-linking agent, a flame retardant, a silica coupling agent, and the like.

In an embodiment, the resin is methyl methacrylate. Methyl methacrylate (MMA) contains a small amount of inhibitor, such as hydroquinone or methyl ether of hydroquinone to prevent polymerization during shipment and storage. Inhibited MMA remains a liquid and free of polymers for long periods. Polymerization of MMA containing inhibitor is performed by removal of the inhibitor. Removal of the inhibitor may be performed by a variety of known methods, including adding a catalyst, such as a thermal initiator, a promoter, radiation, and the like. Suitable amounts of MMA are based on the polymerization conditions and the thickness of the coating. In an embodiment, the catalyst concentration is in the range 0.02% to 0.10% on weight of MMA. Examples of initiators are benzoyl peroxide, lauroyl peroxide, asbenzoin ethers, and the like. In an embodiment, different resins are used for each layer.

In an embodiment, the aggregate is a cement and or a silica. In an embodiment, the aggregate is a hydraulic cement containing various proportions of finely-ground lime, calcium, silicon, metal oxides, and the like. In an embodiment, the aggregate is a Portland cement. Portland cement is a hydraulic cement in which an inorganic material is heat treated at high temperatures, generally in a kiln, to activate the cement. In and embodiment, the aggregate comprises a polymer-modified cementitious (PMC) material added to the cement. The polymers are simple organic molecules (monomers) that combine to form more complex structures through polymerization. PMC materials increase base bonding strength, decrease the effects of freezing and thawing, increase abrasion resistance and flexural and tensile strengths, and reduce permeability.

In an embodiment, the aggregate is an inert granular material, such as sand, gravel, crushed stone, recycled concrete and the like. In an embodiment, the aggregate is a fine aggregate, such as natural sand or crushed stone with particles having a diameter from about less than 10 mm. In an embodiment, the aggregate is a silica sand, a fumed silica, a silica flour and the like. In an embodiment, the aggregate is a coarse aggregate with particle greater than about 10 mm. An aggregate's particle shape and surface texture influence hardening and mixture proportions of the coating. Voids between particles affect the amount of resin required. Absorption and surface moisture of an aggregate influences the final material as well as skid resistance. In an embodiment, harder aggregates are selected to minimize wear.

A suitable amount of aggregate is the amount necessary to ensure complete wetting of the aggregate surfaces. The aggregate/resin proportions will therefore vary with the type and grading of the aggregate. The proportion also varies by temperature, which has an effect on viscosity. In an embodiment, the proportion of aggregate to resin ranges from about 1:1 to about 12:1. In an embodiment, a suitable proportion is an about 4:1 to about 1:1 proportion. In an embodiment, the aggregate provides the “look” of the coating. For example, where the coating is to mimic the look of stained concrete, the aggregate is a hydraulic cement or a silica sand.

In an embodiment, the substrate is a sand, gravel, crushed stone, recycled concrete and the like. In an embodiment, the substrate is a silica sand, a fumed silica, a silica flour, and the like. A suitable amount of substrate is the amount necessary to provide the desired viscosity of the first layer mixture based on the selection of the aggregate. In an embodiment, the substrate provides the “look” of the coating. For example, where the coating is to mimic the look of stained concrete, the substrate is a silica sand.

In an embodiment, the color layer comprises a filler or extender, such but not limited to a silica filler. Suitable fillers include but are not limited to fumed silica and precipitated silica. Fumed silica is silicon dioxide that has a chain-like particle morphology that bonds together via weak hydrogen bonds forming a three dimensional network, trapping liquid and effectively increasing the viscosity. Fumed silica helps prevent sag, keeps pigments from settling, and controls curing. The fumed silica may be chemically modified by alkylation or hydroxylation. In an embodiment, a fine fumed silica is used. An example of a fine fumed silica is that supplied in commercial form and sold by Cabot Corporation under the trademark CAB-O-SIL®. The amount of fumed silica is selected so that the color layer mixture has the proper viscosity for application. In an embodiment, the proper viscosity provides ease in flow and anti-settling.

The present invention comprises a pigment. In an embodiment, the pigment is a chemical compound that provides color and opacity. In an embodiment, the pigment is a fine particle pigment that does not dissolve in water, such as but not limited to inorganic pigments, metallic flakes, quartz, and sand. Selection of a pigment is determined by the physical properties and attributes of the pigment. Suitable pigments are those having properties such as heat stability, lightfastness, hue strength, dispersion, opacity, transparency, resistance to alkalis and acids, and reactions and interactions with other pigments. In an embodiment, the pigment is soluble in resin.

Mixing of the components of each layer is performed in any efficient manner to coat the base. Suitable mixing methods include by hand, small mechanical drum, and large commercial mixers. In an embodiment, finer sized material is added prior to coarser material for proper wetting. Preferably, the entire amount of each layer mixture necessary to cover the base is prepared in a batch to match color when coating large areas.

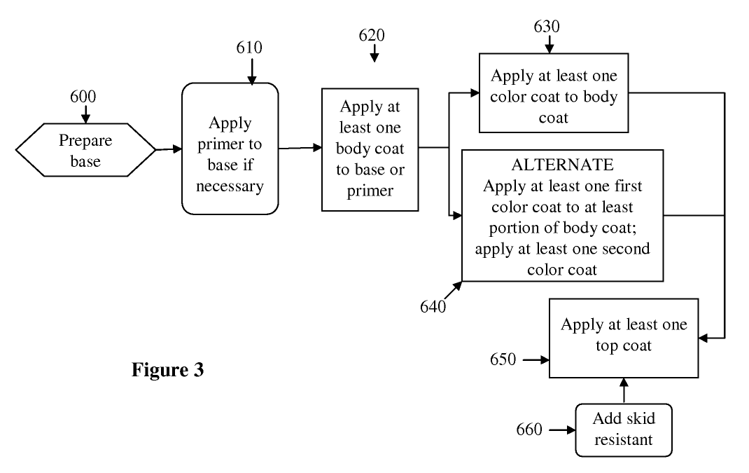

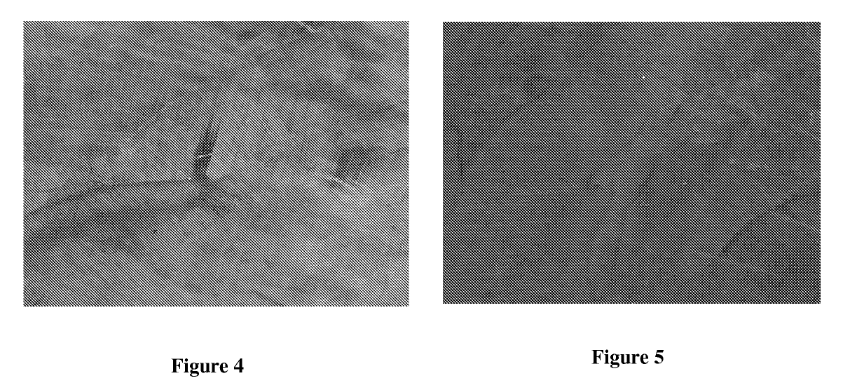

As depicted in FIG. 3, the method of applying the coating comprises the steps of preparing the base 600, optionally applying a primer to the base 610, applying at least one first layer (body coat) to the base and or primer 620, applying at least one color layer (color coat) to all or portions of the first layer 630, alternately applying a second color layer 640, and applying a top layer (top coat) over the color coat 650. A compound to provide slip resistance is optionally added to the top coat 660. Each layer is cured prior to applying the next layer.

The layer mixtures of the present invention are polymerized quickly. Depending on ambient conditions, each layer cures in approximately 45 minutes. The present invention easily covers large surfaces, is applicable to rounded surfaces, and can be applied in any suitable thickness from millimeters to many feet. Thickness is a factor of the condition of the base. In an embodiment, each layer is applied to a depth of approximately ⅛ to ½ inch deep. In an embodiment, the layers are applied at varying depths. In an embodiment, the first layer is applied to a depth from about ⅛ to about 1/16 inch, the color layer is applied to a depth from about 1/32 to about 1/64 inch, and the top layer is applied to a depth from about 1/16 to about 1/32 inch.

In an embodiment, the depth of the first layer varies at the base point to fill cracks, grouting between tiles, joints, and the like, while presenting an approximately level surface opposite the base. In an embodiment, the depth of each layer varies. In an embodiment, the variation in depth is created by spraying, troweling, squeegeeing, scraping, brushing, rolling, power troweling, and the like.

In an embodiment the color layer is opaque or translucent. In an embodiment, the amount of pigment added determines the color intensity of the color layer. In an embodiment, the color layer is applied in varying depths to create portions that contain more intensity. In an embodiment, the color layer is applied by troweling. In an embodiment, the color layer is applied by spraying, brushing, rolling, pouring, scraping, squeegeeing, and the like. In an embodiment, at least one color layer is applied to create a pattern, logo, design, lettering, figures, and the like. In an embodiment, the color layer is applied using a stencil, wherein at least one layer mixture is applied in areas restricted by the stencil.

In an embodiment the top layer is translucent or transparent. In an embodiment, the top layer comprises at least one pigment. In an embodiment, the top layer comprises a component to provide slip resistance, including but not limited to, creating a rough surface, adding a grit, aluminum oxide, sand, glass beads, and the like. In an embodiment, the amount of slip resistance component comprises from about 10 to about 50% of the weight of the top layer of the composition. In an embodiment, the top layer comprises a modifier. Suitable modifiers include but are not limited to a plasticizer, a cross-linking agent, a flame retardant, a silica coupling agent, and the like. Suitable amounts of modifiers are related to the use of the coating. For example, increased amounts of flame retardant is added for fire-resistant coatings.

The coating of the present invention is capable of application to a base at a variety of ambient air temperatures. Due to the creation of heat upon the blending of the compounds of the layers, the coating can be applied at temperatures much lower than the temperatures required for concretes, tile, paint, and the like. Due to the rapid curing time, the coating should not be applied to large areas at temperatures above about 90° F.

In an embodiment, the individual ingredients of each layer are mixed prior to use. In an embodiment, the ingredients of each layer are pre-mixed and the activator is mixed with each layer prior to application. In an embodiment, the pre-mixed layers comprise all of the ingredients except the pigment(s), which is selected from a group of pigment choices and mixed prior to the addition of the activator. In an embodiment, the ingredients of the present invention are packaged in a kit form in quantities suitable to prepare each layer and cover the surface area of the base to be covered. In an embodiment, a kit comprises 1) at least one resin, 2) at least one of a hydraulic cement, a fumed silica, a silica sand, and a silica flour, and 3) a polymerization activator. In an embodiment, the pigments are packaged separately. In an embodiment, the pigments are packaged in pigment kits, which may be based on colors, applications, bases, and the like. In an embodiment, each kit comprises pre-blended components according to layer with an activator packaged separately to be added at the application site.

In an embodiment, the coating of the present invention is used in casting, such as but not limited to poured walls, countertops, enclosures, such as those used for tubs, showers, backspashes, and the like, molded sinks, 3-D objects, and the like. In an embodiment, the coating of the present invention is applied to a base shaped as a tile for application to a wall, floor, ceiling, patio, walkway, and the like.

The coating of the present invention is removeable from the base. In an embodiment, a solvent is applied to the coating and the coating is removed. Suitable solvents include low molecular weight alcohols, acetone, ketones, esters of acid alcohols, and the like.

### EXAMPLES

### First Layer Example #1

1 part resin
1 part Portland cement
0.5 part silica sand
pigment(s)
polymerization activator

### First Layer Example #2

1 part resin
1 part silica sand
0.5 part fumed silica
pigment(s)
polymerization activator

### First Layer Example #3

4 parts resin
2 parts hydraulic cement
1 part fine fumed silica
1 part silica sand
pigment(s)
polymerization activator

### First Layer Example #4

4 parts resin
1 part hydraulic cement
1 part fumed silica
1 part silica sand
pigment(s)
polymerization activator

### First Layer Example #5

4 parts resin
2 parts fine fumed silica
2 parts silica sand
pigment(s)
polymerization activator

### First Layer Example #6

4 parts resin
2 parts hydraulic cement
1 part fine fumed silica
1 part silica flour
pigment(s)
polymerization activator

### First Layer Example #7

4 parts resin
1 part hydraulic cement
1 part silica sand
pigment(s)
polymerization activator

### First Layer Example #8

1 part resin
1 part Portland cement
polymerization activator

### Color Layer Example #1

1 part resin
1.5 part fumed silica
pigment(s)
polymerization activator

### Color Layer Example #2

4 parts resin
1.5 part fumed silica
pigment(s)
polymerization activator

### Color Layer Example #3

1 part resin
pigment(s)
polymerization activator

### Top Layer Example #1

resin
polymerization activator

### Top Layer Example #2

1 part resin
0.5 part aluminum oxide
polymerization activator

Process

In this example, the base is shot blasted and an acrylic primer is applied to the base and allowed to cure. Alternately, the base is prepared by hard grinding, acid etching, mechanical scarifying and the like. In this example, the base is a floor, but any suitable surface or mold will suffice. After the base is prepared, a pigment of the first layer is selected. In this example, the pigment is a metal oxide that produces an opaque sandstone color. The ingredients of the first layer are blended and immediately applied to the floor by troweling. In this example, the first layer is applied in a half circle pattern from one end of the floor to the other using the trowel at an about 45° angle. After application, the first layer is allowed about 20-45 minutes to cure. A pigment of the color layer is selected. In this example, the pigment is a metal oxide producing a transparent blue color. Alternatively, additional pigment(s) and or a metallic flake is added to the color layer. Alternately, the color layer pigment is selected by area and each color layer is applied to a given area over the first layer. Alternately, a second color layer is applied to all or part of the color layer. In this example, the ingredients of the color layer are blended and immediately applied by troweling. In this example, the color layer is applied in a half circle with the trowel edge at an about 75-80° angle to install a very light layer. After about 20-45 minutes, the top layer is applied over the color layer using a brush, roller, sprayer and the like. Alternately, a non-skid ingredient, such as aluminum oxide, is added to the top layer to increase traction.

In this example, the coating is supplied in a kit form where the components of the layers are supplied pre-blended, the pigments are selected and added, and the polymerization activator is added immediately prior to the application of each layer.

The foregoing descriptions of specific embodiments and examples of the present invention have been presented for purposes of illustration and description. They are not intended to be exhaustive or to limit the invention to the precise forms disclosed, and obviously many modifications and variations are possible in light of the above teachings. It will be understood that the invention is intended to cover alternatives, modifications and equivalents. The embodiments were chosen and described in order to best explain the principles of the invention and its practical application, to thereby enable others skilled in the art to best utilize the invention and various embodiments with various modifications as are suited to the particular use contemplated. It is therefore to be understood that within the scope of the appended claims, the invention may be practiced otherwise than as specifically described herein.

I claim:

1. A multiple layer coating composition comprising:
(a) at least one first layer comprising a first layer resin and an aggregate; and
(b) at least one color layer comprising a color layer resin and at least one color layer pigment;
wherein first layer is blended with a polymerization initiator, applied, and allowed to cure and the color layer is blended with a polymerization initiator and applied over the first layer.

2. The multiple layer coating composition of claim 1 wherein the first layer comprises at least one of a substrate and a first layer pigment.

3. The multiple layer coating composition of claim 1 wherein the color layer comprises a filler.

4. The multiple layer coating composition of claim 1 comprising at least one top layer comprising a top layer resin, said top layer blended with a polymerization initiator prior to application and applied over the color layer.

5. The multiple layer coating composition of claim 1 wherein the first layer resin comprises from about 40% to about 70% by weight relative to the total weight of the first layer resin and the aggregate comprises from about 30% to about 60% by weight relative to the total weight of the first layer.

6. The multiple layer coating composition of claim 1 wherein the color layer resin comprises about 99% by weight relative to the total weight of the color layer and the color layer pigment comprises about 1% by weight relative to the total weight of the color layer.

7. The multiple layer coating composition of claim 2 wherein the first layer resin comprises from about 30% to about 60% by weight relative to the total weight of the first layer resin, the substrate comprises from about 10% to about 30% by weight relative to the total weight of the first layer, the aggregate comprises from about 10% to about 40% by weight relative to the total weight of the first layer, and the first layer pigment comprises from about 0.01% to about 1.5% by weight relative to the total weight of the first layer.

8. The multiple layer coating composition of claim 3 wherein
(a) the color layer resin comprises from about 30% to about 60% by weight relative to the total weight of the color layer,
(b) the filler comprises from about 20% to about 70% by weight relative to the total weight of the color layer, and
(c) the color layer pigment comprises from about 0.005% to about 1% by weight relative to the total weight of the color layer.

9. The coating composition of claim 1 wherein the resin is selected from the group consisting of an epoxy, a polyurethane and an acrylic resin.

10. The coating composition of claim 1 wherein the aggregate is selected from the group consisting of a cement, a sand, a gravel, a crushed stone, and a recycled concrete, a silica sand, a fumed silica, and a silica flour.

11. The coating composition of claim 2 wherein the substrate is selected from the group consisting of a cement, a sand, a gravel, a crushed stone, and a recycled concrete, a silica sand, a fumed silica, and a silica flour.

12. The coating composition of claim 3 wherein the filler is selected from the group consisting of a silica filler, a fumed silica and precipitated silica.

13. The coating composition of claim 4 wherein the top layer further comprises a pigment.

14. The coating composition of claim 4 wherein the top layer further comprises at least one of a compound to provide slip resistance and a modifier.

15. The coating composition of claim 1 wherein at least one of the layers is applied by at least one of spraying, troweling, squeegeeing, scraping, brushing, rolling and power troweling.

16. A kit for creating a multiple layer coating composition comprising:
at least one resin;
at least one of a hydraulic cement, a fumed silica, a silica sand, and a silica flour, and;
a polymerization activator.

17. The kit of claim 16 further comprising an array of pigments.

18. A kit for creating a multiple layer coating composition comprising:
a first layer comprising a first layer resin, a substrate, and an aggregate;
a color layer comprising a color layer resin and a filler;
a top layer comprising a top layer resin; and
a polymerization initiator.

19. The kit of claim 18 further comprising at least one pigment.

20. A method of application of the coating composition of claim 1 comprising
applying the first layer to a base;
providing a sufficient amount of time for the first layer to cure;
applying at least one color layer over the first layer; and
providing a sufficient amount of time for the color layer to cure.

21. The method of claim 20 wherein the base is coated with a primer prior to the application of the first layer.

22. The method of claim 20 comprising the additional steps of:
applying a top layer over the color layer; and
providing a sufficient amount of time for the top layer to cure.

23. The method of claim 20 wherein the layers are injected into a mold.
